(19) United States
(12) Patent Application Publication
(10) Pub. No.: US 2008/0241665 A1
(43) Pub. Date: Oct. 2, 2008

(54) ALL-SOLID-STATE LITHIUM-ION SECONDARY BATTERY AND PRODUCTION METHOD THEREOF

(75) Inventor: Atsushi Sano, Tokyo (JP)

Correspondence Address: OLIFF & BERRIDGE, PLC, P.O. BOX 320850, ALEXANDRIA, VA, 22320-4850, US

(73) Assignee: TDK Corporation, Tokyo (JP)

(21) Appl. No.: 12/053,997

(22) Filed: Mar. 24, 2008

(30) Foreign Application Priority Data
Mar. 29, 2007 (JP) 2007-088075

(51) Int. Cl. H01M 10/36; H01M 4/00; B05D 3/00

(52) U.S. Cl. 429/149; 429/122; 429/319; 429/320; 429/304; 429/209; 427/77

(57) ABSTRACT

An all-solid-state lithium-ion secondary battery has an anode, a cathode, a solid electrolyte layer disposed between the anode and the cathode, and at least one of a first mixed region formed at an interface between the anode and the solid electrolyte layer and containing a constituent material of the anode and a constituent material of the solid electrolyte layer, and a second mixed region formed at an interface between the cathode and the solid electrolyte layer and containing a constituent material of the cathode and a constituent material of the solid electrolyte layer.

### BACKGROUND OF THE INVENTION

1. Field of the Invention

The present invention relates to an all-solid-state lithium-ion secondary battery and a production method thereof.

2. Related Background Art

A lithium-ion secondary battery is composed mainly of a cathode, an anode, and an electrolyte layer disposed between the cathode and the anode (e.g., a layer consisting of a liquid electrolyte or a solid electrolyte). In the conventional secondary batteries, the cathode and/or the anode is made using a coating solution (e.g., a solution of a slurry form or a paste form) for formation of the electrode containing an active material for the corresponding electrode, a binder, and a conductive aid.

A variety of research and development has been conducted on the lithium-ion secondary batteries toward further improvement in battery characteristics so as to adapt for future development of portable equipment (e.g., achievement of a higher capacity, improvement in safety, increase in energy density, and so on). Particularly, as to the lithium-ion secondary batteries, an attempt to realize a configuration of a so-called “all-solid-state battery” employing an electrolyte layer consisting of a solid electrolyte is being made from the viewpoints of achieving weight reduction of the battery, increase in energy density, and improvement in safety.

However, the solid electrolyte provides high safety on one hand, but has a problem that it is inferior in rate characteristic to the electrolyte solution because of the smaller number of ion-conduction paths, on the other hand. For remedying this problem, there are the following proposals of production of the all-solid-state battery: a method of forming the solid electrolyte layer by vacuum evaporation (see, for example, Japanese Patent Application Laid-open No. 2004-183078); a method of impregnating a solid electrolyte and an electrode with a polymer solid electrolyte and polymerizing it (see, for example, Japanese Patent Application Laid-open No. 2000-138073), and so on.

### SUMMARY OF THE INVENTION

However, the battery obtained by the method of depositing the solid electrolyte layer by vacuum evaporation has an effective surface area of the interface between the electrode and the electrolyte too small to realize a large electric current, and the high-rate discharge characteristic thereof is still insufficient. The battery obtained by the method of impregnating and polymerizing the polymer solid electrolyte is advantageous in formation of the interface between the electrode active material and the electrolyte but has the ion conductivity lower than that with inorganic solid electrolytes, and the high-rate discharge characteristic thereof is still insufficient.

The present invention has been accomplished in view of the problems in the conventional technologies and an object of the present invention is to provide an all-solid-state lithium-ion secondary battery with excellent high-rate discharge characteristic and a production method thereof.

In order to achieve the above object, the present invention provides an all-solid-state lithium-ion secondary battery comprising: an anode; a cathode; a solid electrolyte layer disposed between the anode and the cathode; and at least one of a first mixed region formed at an interface between the anode and the solid electrolyte layer and containing a constituent material of the anode and a constituent material of the solid electrolyte layer, and a second mixed region formed at an interface between the cathode and the solid electrolyte layer and containing a constituent material of the cathode and a constituent material of the solid electrolyte layer.

Since this all-solid-state lithium-ion secondary battery has the first mixed region and/or the second mixed region, the interface can be continuously formed between the anode and the solid electrolyte layer and/or between the cathode and the solid electrolyte layer, so as to largely increase the effective surface area substantially, whereby excellent high-rate discharge characteristic is achieved.

Preferably, the first mixed region and the second mixed region contain at least a constituent material containing an anion, among constituent materials of the solid electrolyte layer. This all-solid-state lithium-ion secondary battery is further improved in the ion conductivity between the cathode and the solid electrolyte layer and in the ion conductivity between the anode and the solid electrolyte layer, whereby better high-rate discharge characteristic is achieved.

The present invention also provides an all-solid-state lithium-ion secondary battery comprising: an anode; a cathode; and a solid electrolyte layer disposed between the anode and the cathode; wherein the solid electrolyte layer and at least one of the anode and the cathode are obtained by applying a sol solid electrolyte layer precursor for formation of the solid electrolyte layer, and at least one of a sol anode precursor for formation of the anode and a sol cathode precursor for formation of the cathode, in multiple layers in an undried state and thereafter firing the precursors.

Since in the all-solid-state lithium-ion secondary battery the solid electrolyte layer and, the anode and/or the cathode are formed by applying the sol precursors in multiple layers in the undried state and thereafter firing them, a mixed region in which constituent materials of the solid electrolyte layer and the electrode are mixed is formed at the interface between two adjacent layers applied in multiple layers. The existence of this mixed region enables the interface to be continuously formed between the electrode (anode and/or cathode) and the solid electrolyte layer in the all-solid-state lithium-ion secondary battery, so as to largely increase the effective surface area substantially, whereby excellent high-rate discharge characteristic is achieved.

In the all-solid-state lithium-ion secondary battery of the present invention, preferably, the anode contains at least one of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn, an alloy of two or more metals selected from the group, an oxide of the metal, and an oxide of the alloy, or a carbon material. Since the anode contains at least one of these metal, alloy, and oxides thereof the all-solid-state lithium-ion secondary battery can be a battery with higher output/input and a higher capacity.

In the all-solid-state lithium-ion secondary battery of the present invention, preferably, the anode contains a composite material in which at least one of the metal, the alloy, the oxide of the metal, and the oxide of the alloy is supported in a pore of a porous carbon material. Since the anode contains the composite material, the all-solid-state lithium-ion secondary battery can achieve a higher capacity and have better high-rate discharge characteristic and cycle characteristic.

In the all-solid-state lithium-ion secondary battery of the present invention, preferably, the cathode contains an oxide of at least one transition metal selected from the group consisting of Co, Ni, Mn, and Fe. Since the cathode contains the oxide of one of these metals, the all-solid-state lithium-ion secondary battery can be a battery with higher output/input and a higher capacity.

In the all-solid-state lithium-ion secondary battery of the present invention, preferably, the solid electrolyte layer contains at least one of an oxide, sulfide, or phosphate compound of at least one element selected from the group consisting of Ti, Al, La, Ge, Si, Ce, Ga, In, P, and S. The oxide, sulfide, or phosphate compound of one of these elements is a compound which forms a constituent material containing an anion, in the solid electrolyte layer. When the solid electrolyte layer contains at least one of the oxide, sulfide, or phosphate compound of one of these elements, the all-solid-state lithium-ion secondary battery is obtained with the solid electrolyte layer having higher lithium-ion conductivity.

The all-solid-state lithium-ion secondary battery of the present invention preferably comprises a current collector on at least one of a surface of the anode on the opposite side to the solid electrolyte layer and a surface of the cathode on the opposite side to the solid electrolyte layer. This configuration enables the current collector to be used as an electrode terminal in the all-solid-state lithium-ion secondary battery, which contributes to downsizing of apparatus and which prevents lithium ions from moving in the portions other than the space between the anode and the cathode.

The current collector is preferably comprised of Ni. This allows the all-solid-state lithium-ion secondary battery to have lower resistance, and achieves a higher capacity and higher output/input of the battery more adequately. At the same time, it is also feasible to realize cost reduction of the battery.

Furthermore, the all-solid-state lithium-ion secondary battery of the present invention may comprise a plurality of single cells each of which includes the anode, the cathode, and the solid electrolyte layer. This enables construction of the all-solid-state lithium-ion secondary battery with a higher capacity and/or higher voltage.

The present invention also provides a method for producing an all-solid-state lithium-ion secondary battery comprising: an anode; a cathode; and a solid electrolyte layer disposed between the anode and the cathode; the method comprising: a step of applying a sol solid electrolyte layer precursor for formation of the solid electrolyte layer, and at least one of a sol anode precursor for formation of the anode and a sol cathode precursor for formation of the cathode, in multiple layers in an undried state, and thereafter firing the precursors.

In the production method of the all-solid-state lithium-ion secondary battery, the solid electrolyte layer and, the anode and/or the cathode are formed by applying the sol precursors in multiple layers in the undried state and firing them, whereby a mixed region in which constituent materials of the solid electrolyte layer and the electrode are mixed is formed at the interface between two adjacent layers applied in multiple layers. Then the existence of this mixed region drastically enhances the ion conductivity between the electrode (the anode and/or the cathode) and the solid electrolyte layer in the resulting all-solid-state lithium-ion secondary battery, whereby excellent high-rate discharge characteristic is achieved.

In the production method of the all-solid-state lithium-ion secondary battery of the present invention, preferably, the sol anode precursor contains an ion of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn; a hydroxy acid; and a glycol. When the anode is formed using the sol precursor containing these constituent materials, the all-solid-state lithium-ion secondary battery is obtained with a higher capacity and with better high-rate discharge characteristic and cycle characteristic.

In the production method of the all-solid-state lithium-ion secondary battery of the present invention, preferably, the sol cathode precursor contains an ion of at least one transition metal selected from the group consisting of Co, Ni, Mn, and Fe. When the cathode is formed using the sol precursor containing such a constituent material, the resulting all-solid-state lithium-ion secondary battery can be one with a particularly high capacity and with better high-rate discharge characteristic and cycle characteristic.

In the production method of the all-solid-state lithium-ion secondary battery of the present invention, preferably, the sol solid electrolyte layer precursor contains at least one element selected from the group consisting of Ti, Al, La, Ge, Si, Ce, Ga, In, P, and S. When the solid electrolyte layer is formed using the sol precursor containing such a constituent material, the resulting all-solid-state lithium-ion secondary battery can be one with a high capacity and with better high-rate discharge characteristic and cycle characteristic.

Furthermore, in the production method of the all-solid-state lithium-ion secondary battery of the present invention, preferably, the firing is carried out at a temperature of 500° C. or more in the presence of oxygen. When the firing is conducted under such conditions, the resulting all-solid-state lithium-ion secondary battery is obtained as a molded body in which the anode, the solid electrolyte, and the cathode are closely fitted and integrated at each of the interfaces. When the anode, the solid electrolyte, and the cathode are sintered in dense and close fit, the all-solid-state lithium-ion secondary battery comes to have higher ion conductivity.

The present invention successfully provides the all-solid-state lithium-ion secondary battery with excellent high-rate discharge characteristic and the production method thereof.

### BRIEF DESCRIPTION OF THE DRAWINGS

FIG. 1 is a schematic sectional view showing a basic configuration of a preferred embodiment of the all-solid-state lithium-ion secondary battery of the present invention.

FIG. 2 is a schematic sectional view showing a basic configuration of another embodiment of the all-solid-state lithium-ion secondary battery of the present invention.

FIG. 3 is a scanning electron microscope photograph (magnification of ×10000) of a cross section of an anode in the all-solid-state lithium-ion secondary battery obtained in Example 3.

### DESCRIPTION OF THE PREFERRED EMBODIMENTS

The preferred embodiments of the present invention will be described below in detail with reference to the drawings. Identical or equivalent portions will be denoted by the same reference symbols in the drawings, without redundant description. The vertical, horizontal, and other positional relations are based on the positional relations shown in the drawings, unless otherwise stated in particular. Furthermore, the dimensional ratios in the drawings do not always have to be limited to the illustrated ratios.

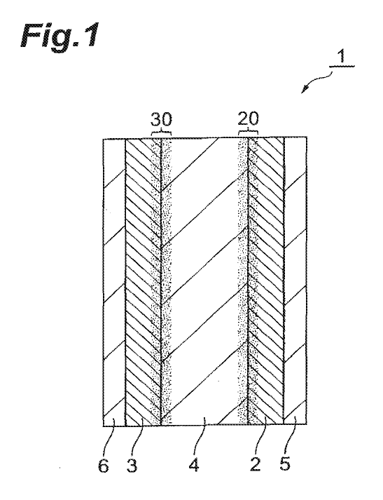

FIG. 1 is a schematic sectional view showing a basic configuration of a preferred embodiment of the all-solid-state lithium-ion secondary battery of the present invention. The all-solid-state lithium-ion secondary battery 1 shown in FIG. 1 is composed mainly of an anode 2 and a cathode 3, and a solid electrolyte layer 4 disposed between the anode 2 and the cathode 3. The “anode” 2 and “cathode” 3 herein are based on the polarities during discharge of the lithium-ion secondary battery 1, for convenience' sake of description. Therefore, the “anode” 2 serves as a “cathode” and the “cathode” 3 as an “anode” during charge.

In the secondary battery 1, a filmlike (platelike or lamellar) current collector (anode collector) 5 is provided on a surface of the anode 2 on the opposite side to the solid electrolyte layer 4, and a filmlike (platelike or lamellar) current collector (cathode collector) 6 is provided on a surface of the cathode 3 on the opposite side to the solid electrolyte layer 4. There are no particular restrictions on the shape of the anode 2 and cathode 3, and they may be formed, for example, in the thin film shape (lamellar shape) as illustrated.

In the secondary battery 1, a first mixed region 20 in which a constituent material of the anode 2 and a constituent material of the solid electrolyte layer 4 are mixed is formed at the interface between the anode 2 and the solid electrolyte layer 4. A second mixed region 30 in which a constituent material of the cathode 3 and a constituent material of the solid electrolyte layer 4 are mixed is formed at the interface between the cathode 3 and the solid electrolyte layer 4.

The anode 2 may be any material containing an anode active material capable of implementing reversible progress of occlusion and release of lithium ions, desorption and insertion of lithium ions, or doping and dedoping with lithium ions and counter anions (e.g., ClO₄⁻) to the lithium ions, and is preferably one containing as an anode active material an oxide of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn.

The anode 2 is also preferably one containing as an anode active material a composite material in which at least one of the metal selected from the group, an alloy of two or more metals selected from the group, and oxides thereof is supported in pores of a porous carbon material. When the anode 2 contains the foregoing composite material, the all-solid-state lithium-ion secondary battery can be formed with a high capacity and with better high-rate discharge characteristic and cycle characteristic.

In the foregoing composite material, the average pore size of the porous carbon material is preferably not more than 5 nm. The average primary particle size of the metal or the alloy thereof or the oxides thereof supported in the pores of the porous carbon material is preferably not less than 10 nm nor more than 500 nm. These can increase rates of occlusion and release of lithium ions. This average primary particle size can be obtained by measuring distances between grain boundaries crossing an arbitrary straight line in a TEM photograph as primary particle sizes at ten points and calculating an average thereof.

Furthermore, the anode 2 may contain graphite, a carbonaceous material, lithium titanate, or the like. A sol precursor of lithium titanate may be used as an anode precursor.

The anode 2 is preferably one formed using a sol anode precursor for formation of the anode 2. This sol anode precursor is preferably one containing an ion of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn. The anode 2 containing an oxide of the selected metal can be formed by firing the sol anode precursor in the presence of oxygen.

When the anode 2 is one containing a composite material in which at least one of the metal from the group, the alloy of two or more metals from the group, and the oxides thereof is supported in pores of a porous carbon material, the sol anode precursor for formation of the anode 2 is preferably one containing an ion of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn; a hydroxy acid; and a glycol. When the sol anode precursor of this kind is fired in an inert atmosphere such as nitrogen or argon, polymerization of a metal complex proceeds by dehydrating condensation between the metal complex with the foregoing metal as a center metal and the hydroxy acid as ligands, and the glycol, and the polymerized metal complex is further thermally decomposed, thereby forming the foregoing composite material in which the metal and/or the alloy is nanodispersed in a carbon matrix. If the composite material is further fired thereafter in the presence of oxygen in an amount so small as to maintain the porous carbon material, the composite material is obtained in a structure in which the oxide of the metal and/or the alloy is nanodispersed in the carbon matrix.

The firing of the sol anode precursor for formation of the composite material is preferably carried out at two stages of temperatures. Namely, it is preferable to perform the first heating at a temperature to polymerize the metal complex and thereafter perform the second heating at a temperature to thermally decompose the polymerized metal complex. The temperature of the first heating is preferably 100-250° C. and the temperature of the second heating is preferably a temperature 20-30° C. lower than the melting point of the metal. When the firing is carried out at two stages of temperatures as described above, the metal complex is first fully polymerized and thereafter thermally decomposed, whereby the metal, the alloy, or the oxide of the metal or the alloy can be supported in a highly dispersed state in a finer carbon matrix, which can further improve the capacity, high-rate discharge characteristic, and cycle characteristic of the secondary battery 1.

The ion of the aforementioned metal can be used, for example, in the form of nitrate, chloride, an organic acid salt, or the like of the metal. The hydroxy acid can be, for example, citric acid, tartaric acid, citramalic acid, isocitric acid, leucine acid, mevalonic acid, pantoic acid, ricinoleic acid, ricinelaidic acid, cerebronic acid, or the like. The glycol can be, for example, ethylene glycol, propylene glycol, diethylene glycol, or the like.

Furthermore, the sol anode precursor may contain an organic solvent such as alcohol, an acid or an alkali acting as a stabilizer or a catalyst for the sol, a polymer for adjustment of viscosity of the sol, and so on. The alcohol can be methanol, ethanol, propanol, butanol, or the like. The acid can be acetic acid, hydrochloric acid, or the like. The polymer can be a cellulose polymer such as methylcellulose, ethylcellulose, or hydroxypropyl methylcellulose, or a polymer usually used as a thickener, e.g., polyacrylic acid, algin acid, polyvinyl alcohol, or polyvinylpyrrolidone.

There are no particular restrictions on the thickness of the anode 2, but from the viewpoint of achieving high-rate characteristic, the thickness of the anode 2 is preferably not less than 0.1 μm nor more than 100 μm and more preferably not less than 0.5 μm nor more than 10 μm.

The cathode 3 may be any cathode containing a cathode active material capable of implementing reversible progress of occlusion and release of lithium ions, desorption and insertion of lithium ions, or doping and dedoping with lithium ions, and is preferably one containing as a cathode active material, an oxide or an olivine-type phosphor compound of at least one transition metal selected from the group consisting of Co, Ni, Mn, and Fe, or a silicon compound or the like. Furthermore, the cathode 3 may contain a sulfide, a carbonaceous material, or the like.

The cathode 3 is preferably one formed using a sol cathode precursor for formation of the cathode 3. This sol anode precursor is preferably one containing an ion of at least one transition metal selected from the group consisting of Co, Ni, Mn, and Fe.

The ion of the foregoing transition metal can be used, for example, in the form of acetate, alkoxide, acetylacetonate, carboxylate, nitrate, oxychloride, chloride, or the like of the transition metal.

Furthermore, the sol cathode precursor may contain an organic solvent such as alcohol, an acid or an alkali acting as a stabilizer or a catalyst for the sol, a polymer for adjustment of viscosity of the sol, and so on. The alcohol can be methanol, ethanol, propanol, butanol, or the like. The acid can be acetic acid, hydrochloric acid, or the like. The polymer can be a cellulose polymer such as methylcellulose, ethylcellulose, or hydroxypropyl methylcellulose, or a polymer usually used as a thickener, e.g., polyacrylic acid, algin acid, polyvinyl alcohol, or polyvinylpyrrolidone.

There are no particular restrictions on the thickness of the cathode 3, but from the viewpoint of increase in output/input density of ion, the thickness of the cathode 3 is preferably not less than 0.1 μm nor more than 100 μm and more preferably not less than 0.3 μm nor more than 10 μm.

There are no particular restrictions on the solid electrolyte layer 4 as long as it has the conductivity of lithium ions. However, the solid electrolyte layer 4 is preferably one containing an oxide of at least one element selected from the group consisting of Ti, Al, La, Ge, Si, Ce, Ga, In, P, and S; and a lithium salt such as lithium acetate or lithium isopropoxide, or an alkali metal salt consisting primarily of lithium. The solid electrolyte layer 4 is also preferably one containing a phosphate compound represented by the general formula (1);

Li₁₊ₓAlₓTi₂₋ₓ(PO₄)₃ (1)

(0≦x≦2).

Furthermore, the solid electrolyte layer 4 may contain a lithium-ion-conductive NASICON-type compound, a sulfide such as Li₂S/P₂S₅, a lithium-ion-conductive oxide such as Li_{0.34}La_{0.51}TiO_{2.94}, a phosphate compound such as LiPON, or the like.

These phosphate compound, lithium-ion-conductive NASICON-type compound, sulfide, lithium-ion-conductive oxide, and phosphate compound are positioned as a constituent material containing an anion, in the solid electrolyte layer 4. For example, PO₄³⁻ is an anion in Li₁₊ₓAlₓTi₂₋ₓ(PO₄)₃; S₂⁻ is an anion in Li₂S/P₂S₅; O₂⁻ is an anion in Li_{0.34}La_{0.51}TiO_{2.94}.

The solid electrolyte layer 4 is preferably one formed using a sol solid electrolyte layer precursor for formation of the solid electrolyte layer 4. This sol solid electrolyte layer precursor is preferably one containing a compound containing at least one element selected from the group consisting of Ti, Al, La, Ge, Si, Ce, Ga, In, P, and S; and a lithium salt such as lithium acetate or lithium isopropoxide, or an alkali metal salt consisting primarily of lithium. Specific examples of compounds containing the above-listed elements include titanium tetra-tert-butoxide, titanium tetra-n-butoxide, aluminum butoxide, ammonium dihydrogenphosphate, and so on.

Furthermore, the sol solid electrolyte layer precursor may contain an organic solvent such as alcohol, an acid or an alkali acting as a stabilizer or a catalyst for the sol, a polymer for adjustment of viscosity of the sol, and so on. The alcohol can be methanol, ethanol, propanol, butanol, or the like. The acid can be acetic acid, hydrochloric acid, or the like. The polymer can be a cellulose polymer such as methylcellulose, ethylcellulose, or hydroxypropyl methylcellulose, or a polymer usually used as a thickener, e.g., polyacrylic acid, algin acid, polyvinyl alcohol, polyvinylpyrrolidone or the like.

There are no particular restrictions on the thickness of the solid electrolyte layer 4, but from the viewpoint of achievement of high-rate characteristic, the thickness of the solid electrolyte layer 4 is preferably not less than 0.1 μm nor more than 100 μm and more preferably not less than 0.3 μm nor more than 10 μm.

The first mixed region 20 is a region containing a constituent material of the aforementioned anode 2 and a constituent material of the solid electrolyte layer 4. This first mixed region 20 can be formed by applying the sol anode precursor and the sol solid electrolyte layer precursor in multiple layers and thereafter firing them. The multilayer application herein is implemented by applying an upper layer onto a lower layer in an undried state. By adopting this method, the sol precursors are mixed with each other near the interface between the lower layer and the upper layer, and the lower layer and the upper layer are simultaneously fired in a state in which the constituent material containing an anion among those of the solid electrolyte layer 4, and the constituent material of the anode 2 coexist, whereby the first mixed region 20 is formed.

The second mixed region 30 is a region containing a constituent material of the aforementioned cathode 3 and a constituent material of the solid electrolyte layer 4. This second mixed region 30 can be formed by applying the sol cathode precursor and the sol solid electrolyte layer precursor in multiple layers and thereafter firing them. The multilayer application herein is implemented by applying an upper layer onto a lower layer in an undried state. By adopting this method, the sol precursors are mixed with each other near the interface between the lower layer and the upper layer, and the lower layer and the upper layer are simultaneously fired in a state in which the constituent material containing an anion among those of the solid electrolyte layer 4, and the constituent material of the cathode 3 coexist, whereby the second mixed region 30 is formed.

In the case where the first mixed region 20 and the second mixed region 30 both are formed like the secondary battery 1 shown in FIG. 1, they can be formed by applying three precursors, the sol anode precursor, the sol solid electrolyte layer precursor and the sol cathode precursor, in multiple layers in an undried state and thereafter firing all of them at the same time.

As the secondary battery 1 has such first mixed region 20 and second mixed region 30, the ion conductivity is drastically enhanced between the anode 2 and the solid electrolyte layer 4 and between the cathode 3 and the solid electrolyte layer 4 in the secondary battery 1, so as to enable achievement of excellent high-rate discharge characteristic. For example, if the anode, the cathode, and the solid electrolyte are prepared as separate solids and fired in contact to effect solid-phase diffusion, it is very difficult to effect the solid-phase diffusion of the constituent material containing the anion among those of the solid electrolyte layer, into the cathode or the anode, and it is thus hard to achieve the same effect as the present invention has achieved.

The all-solid-state lithium-ion secondary battery of the present invention may be one having only one of the first mixed region 20 and the second mixed region 30. Even in this case, the ion conductivity is enhanced between the solid electrolyte layer 4 and the electrode (anode 2 or cathode 3) on the side where the mixed region exists, and therefore the high-rate discharge characteristic can be improved, as compared with the case without the mixed region.

There are no particular restrictions on the thickness of the first mixed region 20 and the second mixed region 30, but from the viewpoint of increase in the interface area, the thickness is preferably not less than 0.01 μm nor more than 10 μm and more preferably not less than 0.05 μm nor more than 1 μm.

There are no particular restrictions on the constituent material of the anode collector 5 as long as it has electron conductivity. For example, the constituent material is nickel or copper or the like, and is preferably nickel. Furthermore, there are no particular restrictions on the constituent material of the cathode collector 6 as long as it has electron conductivity. For example, the constituent material is nickel, aluminum, tantalum, iron, titanium or the like and preferably nickel, aluminum, or tantalum.

Next, a preferred embodiment of the production method of the all-solid-state lithium-ion secondary battery of the present invention will be described using an example of producing the all-solid-state lithium-ion secondary battery 1 shown in FIG. 1.

First, a base such as a PET film is prepared, and a metal paste for formation of the anode collector 5 is applied onto the base, and dried to form the anode collector 5.

The application of the metal paste herein can be implemented by screen printing, nozzle application, doctor blade application, or the like. The drying is normally carried out at the temperature of 80-250° C. though it depends upon a type and an amount of a solvent contained in the metal paste.

Next, the sol anode precursor is applied onto the anode collector 5, the sol solid electrolyte layer precursor is then applied onto it before a coating film of the anode precursor is dried, and the sol cathode precursor is further applied onto it before a coating film of the solid electrolyte layer precursor is dried.

There are no particular restrictions on how to apply each sol precursor, but each sol precursor can be applied, for example, by screen printing, nozzle application, doctor blade application, or the like. From the viewpoint of forming the first mixed region 20 and the second mixed region 30 more reliably, it is preferable to simultaneously form the coating films of the respective sol precursors by simultaneous multilayer application.

Then, the base is peeled off from the anode collector 5 and thereafter the whole is fired to form the anode 2, the solid electrolyte layer 4, and the cathode 3 on the anode collector 5.

The firing is preferably carried out at the temperature of 500° C. or more and more preferably at the temperature of 600-800° C. in the presence of oxygen though it depends upon the compositions of the respective sol precursors. It is also preferable to perform drying at a lower temperature than that for the firing, before execution of the firing. The drying is preferably carried out at the temperature of 80-250° C. though it depends upon types and amounts of solvents contained in the respective sol precursors.

Next, a metal paste for formation of the cathode collector 6 is applied onto the cathode 3 and dried to form the cathode collector 6. The application and drying of the metal paste herein are carried out under the same conditions as in the case where the anode collector 5 is formed.

Thereafter, the resultant is sealed except for portions to be exposed in the current collectors, by a resin mold or the like (not shown) according to need, thereby obtaining the all-solid-state lithium-ion secondary battery 1.

When the all-solid-state lithium-ion secondary battery is produced by the above-described method, the first mixed region 20 is formed at the interface between the anode 2 and the solid electrolyte layer 4 and the second mixed region 30 is formed at the interface between the cathode 3 and the solid electrolyte layer 4. For this reason, the ion conductivity is drastically enhanced between the anode 2 and the solid electrolyte layer 4 and between the cathode 3 and the solid electrolyte layer 4, so as to obtain the all-solid-state lithium-ion secondary battery 1 with excellent high-rate discharge characteristic.

The above described the preferred embodiments of the present invention, but it should be noted that the present invention is by no means limited to the above embodiments.

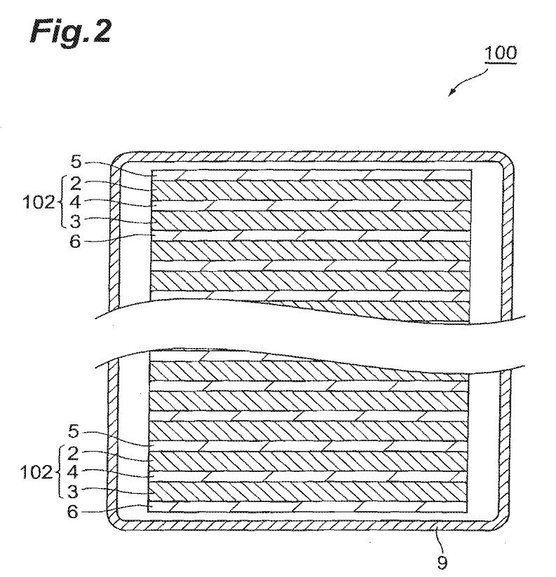

For example, the all-solid-state lithium-ion secondary battery of the present invention may have a configuration of a module 100, as shown in FIG. 2, in which a plurality of single cells (each of which is a cell consisting of the anode 2, cathode 3, and solid electrolyte layer 4) 102 are stacked through the anode collector 5 and the cathode collector 6 and in which they are held (packaged) in a hermetically closed state in a predetermined case 9. The module may also be constructed without use of the case 9, by sealing it except for the portions to be exposed in the current collectors, by a resin mold or the like.

Furthermore, in the above case, the single cells may be connected in parallel or in series. For example, it is also possible to construct a battery unit in which a plurality of above-described modules 100 are electrically connected in series or in parallel.

Furthermore, in the case of construction of the above-described module or battery unit, a protection circuit or a PTC element similar to those in the existing batteries may be further provided according to need.

The above embodiment described the production method of the all-solid-state lithium-ion secondary battery of the present invention, using the example of forming the secondary battery from the anode 2 side, but there are no particular restrictions on the sequence of production; the secondary battery may be formed either from the anode 2 side or from the cathode 3 side.

When the anode 2 contains the composite material in which the metal, the alloy, or the oxide of the metal or the alloy is supported in pores of the porous carbon material as described above, it is necessary to fire the sol anode precursor in an inert atmosphere not containing oxygen. Therefore, in the case where the anode 2 of this configuration is used, it is preferable to adopt the following production method: the sol cathode precursor and the sol solid electrolyte layer precursor are applied in multiple layers and fired in the presence of oxygen, thereafter the sol anode precursor is applied onto the solid electrolyte 4 after fired, and then the resultant is fired in an inert atmosphere.

The anode collector 5 and the cathode collector 6 may also be formed after formation of the anode 2, solid electrolyte layer 4, and cathode 3. In this case, it is preferable to adopt a method of applying the metal paste onto the undried sol precursors and then firing the whole. In that case, the interfacial conditions are enhanced between the anode 2 and the anode collector 5 and between the cathode 3 and the cathode collector 6, so as to improve the electron conductivity. Furthermore, in the case where the module 100 is formed by stacking a plurality of single cells 102 each including the anode 2, solid electrolyte layer 4, and cathode 3 as shown in FIG. 2, it is preferable to stack all the single cells 102 and precursors of current collectors 5, 6 in an undried state and fire the whole at the same time, which can enhance the ion conductivity and electron conductivity of the entire laminate.

The present invention will be described below in more detail on the basis of examples and comparative examples, but it should be noted that the present invention is by no means intended to be limited to the examples below.

### EXAMPLE 1

1.25 equivalents of lithium acetate were mixed in 1 equivalent of titanium isopropoxide, and 20 equivalents of isopropanol and 1 equivalent of polyvinylpyrrolidone were further added therein and stirred to obtain a sol anode precursor.

6 equivalents of titanium butoxide, 10 equivalents of ammonium dihydrogenphosphate, and 5 equivalents of lithium acetate were mixed in 1 equivalent of aluminum butoxide, and 20 equivalents of butanol were further added therein and stirred to obtain a sol solid electrolyte layer precursor.

1 equivalent of lithium acetate, 20 equivalents of acetic acid, 20 equivalents of water, 20 equivalents of isopropanol, and 1 equivalent of polyvinylpyrrolidone were added in 1 equivalent of cobalt acetate and stirred to obtain a sol cathode precursor.

Next, a Ni paste was applied onto a PET film and dried to form a Ni layer as a current collector. The sol anode precursor was applied onto this Ni layer by a nozzle method. Subsequently, a nozzle was set over a coating film immediately after the application of the sol anode precursor, and the sol solid electrolyte layer precursor was applied onto the coating film of the anode precursor by the nozzle method. Subsequently, a nozzle was set over a coating film immediately after the application of the sol solid electrolyte layer precursor, and the sol cathode precursor was applied onto the coating film of the solid electrolyte layer precursor by the nozzle method. This resulted in laminating the anode precursor coating film, solid electrolyte layer precursor coating film, and cathode precursor coating film each in an undried state in this order on the Ni layer. This laminate was put in a drying furnace and dried at 200° C. for one hour. The PET film was peeled off from the laminate after dried, and the laminate was fired at 700° C. in an oxygen atmosphere for three hours to obtain a battery element sheet in which the Ni layer, the anode (thickness: 3 μm), the solid electrolyte layer (thickness: 5 μm), and the cathode (thickness: 3 μm) were stacked in this order.

Ten battery element sheets of this structure were stacked and the stack was cut in the size of 0.5 cm×0.5 cm to obtain a laminate of chip shape. A Ni paste was applied onto one end face on the side where the cathode of the chip laminate was exposed, and it was dried to form a Ni layer as a current collector. Then, the upper and lower end faces (Ni layers) of the chip laminate were plated with nickel to form external output terminals. Thereafter, the peripheral part of the chip laminate except for the external output terminals was sealed by a resin mold to fabricate a chip-type all-solid-state lithium-ion secondary battery.

With the resulting all-solid-state lithium-ion secondary battery, the interface between the anode and the solid electrolyte layer and the interface between the cathode and the solid electrolyte layer were checked by structural observation with a scanning electron microscope (SEM) and a transmission electron microscope (TEM), and it was confirmed that the mixed region (thickness: 0.5 μm) in which the constituent materials of the anode and the solid electrolyte layer were mixed was formed at the interface between the anode and the solid electrolyte layer and that the mixed region (thickness: 0.3 μm) in which the constituent materials of the cathode and the solid electrolyte layer were mixed was formed at the interface between the cathode and the solid electrolyte layer.

### EXAMPLE 2

A chip-type all-solid-state lithium-ion secondary battery of Example 2 was fabricated in the same manner as in Example 1, except that screen printing was employed instead of the nozzle method, as the method of applying the anode precursor solid electrolyte layer precursor, and cathode precursor.

With the resulting all-solid-state lithium-ion secondary battery, the interface between the anode and the solid electrolyte layer and the interface between the cathode and the solid electrolyte layer were checked with SEM and TEM and it was confirmed that the mixed region (thickness: 0.5 μm) in which the constituent materials of the anode and the solid electrolyte layer were mixed was formed at the interface between the anode and the solid electrolyte layer and that the mixed region (thickness: 0.3 μm) in which the constituent materials of the cathode and the solid electrolyte layer were mixed was formed at the interface between the cathode and the solid electrolyte layer.

### EXAMPLE 3

A chip-type all-solid-state lithium-ion secondary battery of Example 3 was fabricated in the same manner as in Example 1, except that spin coating was employed instead of the nozzle method, as the method of applying the anode precursor, solid electrolyte layer precursor, and cathode precursor.

With the resulting all-solid-state lithium-ion secondary battery, the interface between the anode and the solid electrolyte layer and the interface between the cathode and the solid electrolyte layer were checked with SEM and TEM and it was confirmed that the mixed region (thickness: 0.3 μm) in which the constituent materials of the anode and the solid electrolyte layer were mixed was formed at the interface between the anode and the solid electrolyte layer and that the mixed region (thickness: 0.3 μm) in which the constituent materials of the cathode and the solid electrolyte layer were mixed was formed at the interface between the cathode and the solid electrolyte layer.

### EXAMPLE 4

Tin chloride and iron nitrate were weighed at Sn:Fe=1:1 (molar ratio) and 5 equivalents of citric acid monohydrate, and 20 equivalents of ethylene glycol were added relative to the total number of moles of Sn and Fe. The resulting mixture was stirred at 50° C. for five hours to obtain a sol anode precursor. The sol solid electrolyte layer precursor and the sol cathode precursor were prepared in the same manner as in Example 1.

Next, a Ni paste was applied onto a PET film and dried to form a Ni layer as a current collector. The sol cathode precursor was applied onto this Ni layer by the nozzle method. Subsequently, a nozzle was set over a coating film immediately after the application of the sol cathode precursor, and the sol solid electrolyte layer precursor was applied onto the coating film of the cathode precursor by the nozzle method. This resulted in laminating the cathode precursor coating film and the solid electrolyte layer precursor coating film each in an undried state in this order on the Ni layer. This laminate was put into a drying furnace and dried at 200° C. for one hour. Then the PET film was peeled off from the laminate after dried, and the laminate was fired at 600° C. in an oxygen atmosphere for one hour to form the cathode and the solid electrolyte layer on the Ni layer.

Next, the aforementioned sol anode precursor was applied onto the solid electrolyte layer after fired, by the nozzle method and was dried at 200° C. in a drying furnace for one hour. The laminate after dried was fired at 700° C. in an argon atmosphere for one hour to obtain a battery element sheet in which the Ni layer, the cathode (thickness: 5 μm), the solid electrolyte layer (thickness: 2 μm), and the anode (thickness: 5 μm) were stacked in this order.

Ten battery element sheets of this structure were stacked and the stack was cut in the size of 0.5 cm×0.5 cm to obtain a laminate of chip shape. A Ni paste was applied onto one end face on the side where the anode of the chip laminate was exposed, and it was dried to form a Ni layer as a current collector. Then, the upper and lower end faces (Ni layers) of the chip laminate were plated with nickel to form external output terminals. Thereafter, the peripheral part of the chip laminate except for the external output terminals was sealed by a resin mold to fabricate a chip-type all-solid-state lithium-ion secondary battery.

With the resulting all-solid-state lithium-ion secondary battery, the interface between the anode and the solid electrolyte layer and the interface between the cathode and the solid electrolyte layer were checked with SEM and TEM and it was confirmed that there was a clear boundary between two layers at the interface between the anode and the solid electrolyte layer, without the mixed region in which the constituent materials of the two layers were mixed, and that the mixed region (thickness: 0.5 μm) in which the constituent materials of the cathode and the solid electrolyte layer were mixed was formed at the interface between the cathode and the solid electrolyte layer.

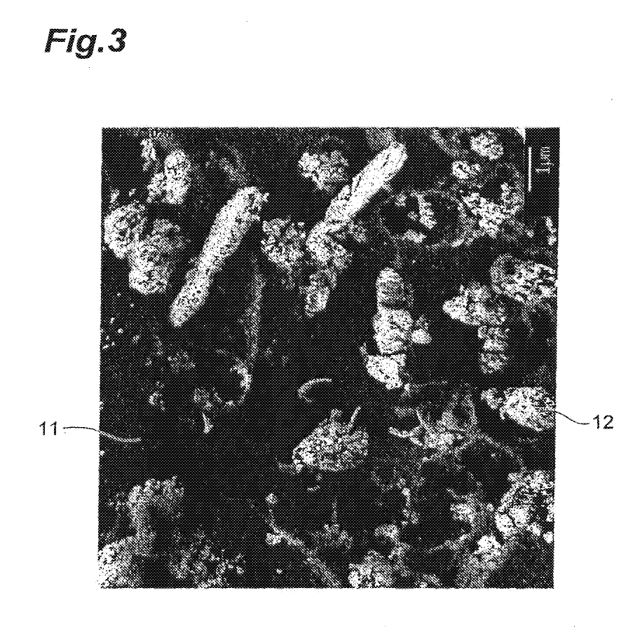

FIG. 3 shows a scanning electron microscope photograph (magnification: ×10000) of a cross section of the anode in the resulting all-solid-state lithium-ion secondary battery. As shown in FIG. 3, it was confirmed that the anode was composed of a composite material in which a metal (FeSn alloy) 12 was supported in pores of a porous carbon material 11.

### COMPARATIVE EXAMPLE 1

The sol anode precursor, sol solid electrolyte layer precursor, and sol cathode precursor were prepared in the same manner as in Example 1. Next, a Ni paste was applied onto a PET film and dried to form a Ni layer as a current collector. The sol anode precursor was applied onto this Ni layer by the nozzle method. This laminate was put into a drying furnace and dried at 200° C. for one hour. Then the PET film was peeled off from the laminate after dried, and the laminate was fired at 700° C. in an oxygen atmosphere for one hour to obtain an anode sheet in which the anode was laid on the Ni layer.

The sol cathode precursor was applied onto a heat-resistant glass by the nozzle method and dried at 200° C. in a drying furnace for one hour. Then the resultant was fired at 600° C. in an oxygen atmosphere for 3 hours and the cathode was peeled off from the heat-resistant glass to obtain a cathode sheet.

The sol solid electrolyte layer precursor was applied onto a heat-resistant glass by the nozzle method and dried at 200° C. in a drying furnace for one hour. Then the resultant was fired at 600° C. in an oxygen atmosphere for 3 hours and the solid electrolyte layer was peeled off from the heat-resistant glass to obtain an electrolyte sheet.

The anode sheet, electrolyte sheet, and cathode sheet thus obtained were stacked and fired at 600° C. in an oxygen atmosphere for one hour to obtain a battery element sheet in which the Ni layer, the anode (thickness: 5 μm), the solid electrolyte layer (thickness: 3 μm), and the cathode (thickness: 5 μm) were stacked in this order.

Ten battery element sheets of this structure were stacked and the stack was cut in the size of 0.5 cm×0.5 cm to obtain a laminate of chip shape. A Ni paste was applied onto one end face on the side where the cathode of the chip laminate was exposed, and it was dried to form a Ni layer as a current collector. Then, the upper and lower end faces (Ni layers) of the chip laminate were plated with nickel to form external output terminals. Thereafter, the peripheral part of the chip laminate except for the external output terminals was sealed by a resin mold to fabricate a chip-type all-solid-state lithium-ion secondary battery.

With the resulting all-solid-state lithium-ion secondary battery, the interface between the anode and the solid electrolyte layer and the interface between the cathode and the solid electrolyte layer were checked with SEM and TEM, and it was confirmed that there was a clear boundary between two adjacent layers at each of the interfaces, without formation of the mixed region in which the constituent materials of the two layers were mixed.

### COMPARATIVE EXAMPLE 2

The sol anode precursor and the sol cathode precursor were prepared in the same manner as in Example 1. Next, a Ni paste was applied onto a PET film and dried to form a Ni layer as a current collector. The sol anode precursor was applied onto this Ni layer by the nozzle method and dried. Subsequently, 45 parts by mass of particles of Li_{1.3}Al_{0.3}Ti_{1.7}(PO₄)₃ were mixed with 5 parts by mass of polyvinylpyrrolidone as a thickener and 50 parts by mass of distilled water were added as a solvent therein to prepare a coating solution. Li_{1.3}Al_{0.3}Ti_{1.7}(PO₄)₃ used herein was one obtained by mixing Li₂CO₃, Al₂O₃, TiO₂, and (NH₄)₂HPO₄ at a stoichiometric ratio, firing the mixture at 900° C., and pulverizing the resultant. This coating solution was applied onto the coating film of the anode precursor and dried to form the solid electrolyte layer on the coating film of the anode precursor. Subsequently, the sol cathode precursor was applied onto the solid electrolyte layer by the nozzle method and dried. This resulted in laminating the anode precursor coating film, solid electrolyte layer, and cathode precursor coating film in this order on the Ni layer. This laminate was put into a drying furnace and dried at 200° C. for one hour. The PET film was peeled off from the laminate after dried, and the laminate was fired at 700° C. in an oxygen atmosphere for one hour to obtain a battery element sheet in which the Ni layer, the anode (thickness: 5 μm), the solid electrolyte layer (thickness: 10 μm), and the cathode (thickness: 5 μm) were stacked in this order.

Ten battery element sheets of this structure were stacked and the stack was cut in the size of 0.5 cm×0.5 cm to obtain a laminate of chip shape, A Ni paste was applied onto one end face on the side where the cathode of the chip laminate was exposed, and it was dried to form a Ni layer as a current collector. Then, the upper and lower end faces (Ni layers) of the chip laminate were plated with nickel to form external output terminals. Thereafter, the peripheral part of the chip laminate except for the external output terminals was sealed by a resin mold to fabricate a chip-type all-solid-state lithium-ion secondary battery.

With the resulting all-solid-state lithium-ion secondary battery, the interface between the anode and the solid electrolyte layer and the interface between the cathode and the solid electrolyte layer were checked with SEM and TEM, and it was confirmed that there was a clear boundary between two adjacent layers at each of the interfaces, without formation of the mixed region in which the constituent materials of the two layers were mixed.

<Evaluation of High-Rate Discharge Characteristic> For each of the all-solid-state lithium-ion secondary batteries obtained in Examples 1-4 and Comparative Examples 1-2, a percentage (%) of 2 C capacity was determined relative to 1 C capacity as 100%, where 1 C was an electric current value to a discharge end in one hour in execution of constant-current discharge at the discharge temperature of 25° C. and the 1 C capacity was a discharge capacity achieved at that time. The results are presented in Table 1 below.

TABLE 1

| | High-rate discharge characteristic |
|---|---|
| | (2C/1C) |
| | (%) |
| Example 1 | 85 |
| Example 2 | 78 |
| Example 3 | 76 |
| Example 4 | 80 |
| Comparative Example 1 | 50 |
| Comparative Example 2 | 3 |

What is claimed is:

1. An all-solid-state lithium-ion secondary battery comprising:
an anode;
a cathode;
a solid electrolyte layer disposed between the anode and the cathode; and
at least one of a first mixed region formed at an interface between the anode and the solid electrolyte layer and containing a constituent material of the anode and a constituent material of the solid electrolyte layer, and a second mixed region formed at an interface between the cathode and the solid electrolyte layer and containing a constituent material of the cathode and a constituent material of the solid electrolyte layer.

2. The all-solid-state lithium-ion secondary battery according to claim 1, wherein the first mixed region and the second mixed region contain at least a constituent material containing an anion, among constituent materials of the solid electrolyte layer.

3. An all-solid-state lithium-ion secondary battery comprising:
an anode;
a cathode; and
a solid electrolyte layer disposed between the anode and the cathode;
wherein the solid electrolyte layer and at least one of the anode and the cathode are obtained by applying a sol solid electrolyte layer precursor for formation of the solid electrolyte layer, and at least one of a sol anode precursor for formation of the anode and a sol cathode precursor for formation of the cathode, in multiple layers in an undried state and thereafter firing the precursors.

4. The all-solid-state lithium-ion secondary battery according to claim 1, wherein the anode contains at least one of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn, an alloy of two or more metals selected from the group, an oxide of said metal, and an oxide of said alloy.

5. The all-solid-state lithium-ion secondary battery according to claim 3, wherein the anode contains at least one of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr Cr, Mo, Nb, V, and Zn, an alloy of two or more metals selected from the group, an oxide of said metal, and an oxide of said alloy.

6. The all-solid-state lithium-ion secondary battery according to claim 4, wherein the anode contains a composite material in which at least one of said metal, said alloy, the oxide of said metal, and the oxide of said alloy is supported in a pore of a porous carbon material.

7. The all-solid-state lithium-ion secondary battery according to claim 5, wherein the anode contains a composite material in which at least one of said metal, said alloy, the oxide of said metal, and the oxide of said alloy is supported in a pore of a porous carbon material.

8. The all-solid-state lithium-ion secondary battery according to claim 1, wherein the cathode contains an oxide of at least one transition metal selected from the group consisting of Co, Ni, Mn, and Fe.

9. The all-solid-state lithium-ion secondary battery according to claim 3, wherein the cathode contains an oxide of at least one transition metal selected from the group consisting of Co, Ni, Mn, and Fe.

10. The all-solid-state lithium-ion secondary battery according to claim 1, wherein the solid electrolyte layer contains at least one of an oxide, sulfide, or phosphate compound of at least one element selected from the group consisting of Ti, Al, La, Ge, Si, Ce, Ga, In, P, and S.

11. The all-solid-state lithium-ion secondary battery according to claim 3, wherein the solid electrolyte layer contains at least one of an oxide, sulfide, or phosphate compound of at least one element selected from the group consisting of Ti, Al, La, Ge, Si, Ce, Ga, In, P, and S.

12. The all-solid-state lithium-ion secondary battery according to claim 1, comprising a current collector on at least one of a surface of the anode on the opposite side to the solid electrolyte layer and a surface of the cathode on the opposite side to the solid electrolyte layer.

13. The all-solid-state lithium-ion secondary battery according to claim 3, comprising a current collector on at least one of a surface of the anode on the opposite side to the solid electrolyte layer and a surface of the cathode on the opposite side to the solid electrolyte layer.

14. The all-solid-state lithium-ion secondary battery according to claim 1, comprising a plurality of single cells each of which includes the anode, the cathode, and the solid electrolyte layer.

15. The all-solid-state lithium-ion secondary battery according to claim 3, comprising a plurality of single cells each of which includes the anode, the cathode, and the solid electrolyte layer.

16. A method for producing an all-solid-state lithium-ion secondary battery comprising:
an anode;
a cathode; and
a solid electrolyte layer disposed between the anode and the cathode;
the method comprising: a step of applying a sol solid electrolyte layer precursor for formation of the solid electrolyte layer, and at least one of a sol anode precursor for formation of the anode and a sol cathode precursor for formation of the cathode, in multiple layers in an undried state, and thereafter firing the precursors.

17. The method according to claim 16, wherein the sol anode precursor contains an ion of at least one metal selected from the group consisting of Sn, Si, Al, Ge, Sb, Ag, Ga, In, Fe, Co, Ni, Ti, Mn, Ca, Ba, La, Zr, Ce, Cu, Mg, Sr, Cr, Mo, Nb, V, and Zn; a hydroxy acid; and a glycol.

18. The method according to claim 16, wherein the sol cathode precursor contains an ion of at least one transition metal selected from the group consisting of Co, Ni, Mn, and Fe.

19. The method according to claim 16, wherein the sol solid electrolyte layer precursor contains at least one element selected from the group consisting of Ti, Al, La, Ge, Si, Ce, Ga, In, P, and S.

20. The method according to claim 16, wherein the firing is carried out at a temperature of 500° C. or more in the presence of oxygen.
